(19) United States
(12) Patent Application Publication
(10) Pub. No.: US 2004/0142672 A1
(43) Pub. Date: Jul. 22, 2004

(54) Method for suppressing disturbing noise

(76) Inventor: Britta Stankewitz, Pforzheim (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/701,630

(22) Filed: Nov. 6, 2003

(30) Foreign Application Priority Data
Nov. 6, 2002 (DE) 102 516 03.0

(51) Int. Cl. H04B 1/10

(52) U.S. Cl. 455/296; 455/569.1; 455/297

(57) ABSTRACT

A method of suppressing ambient noise in telephone calls between at least two telephone partners measures the ambient noise and determines the parameters for suppressing this ambient noise on the basis of an algorithm. When using a cell phone in a motor vehicle, the vehicle parameters are detected when it is detected that a connection is being established. On the basis of the vehicle parameters currently being detected, the starting parameters for the interference noise suppression are derived from a characteristics map which was determined in the application.

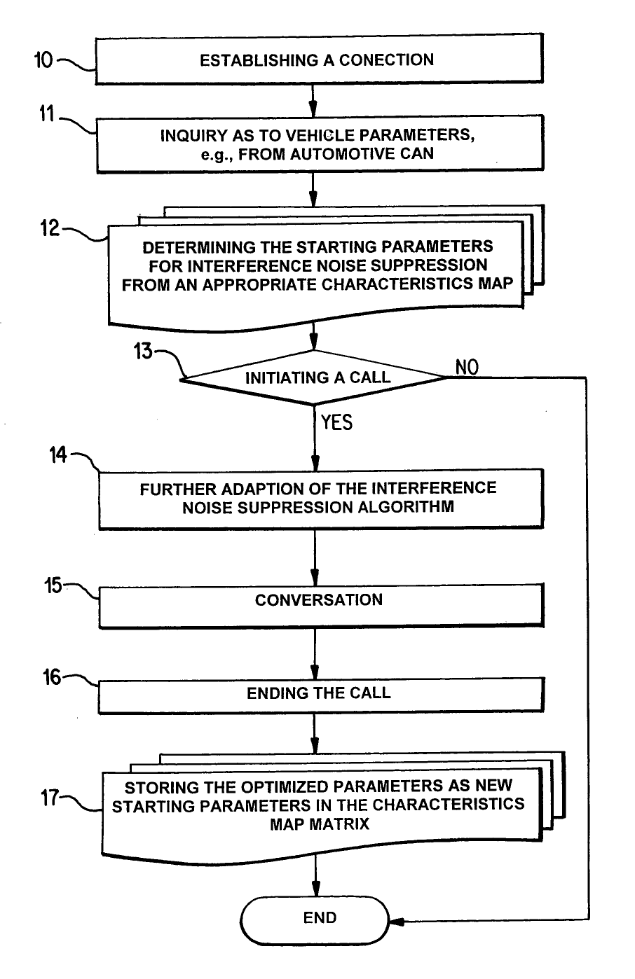

### BACKGROUND OF THE INVENTION

This application claims the priority of German Patent Application No. 102 51 603.0, filed Nov. 6, 2002, the disclosure of which is expressly incorporated by reference herein.

The present invention relates to a method of suppressing interference noise in the use of a cell phone, whereby in the methods known in the related art, algorithms are generally used to isolate the voice of the user of the cell phone from the other sounds or noises in the environment of the cell phone.

The problem with many known algorithms is that a certain amount of time is required to effectively suppress interference noise after the start of a call. This period of time is usually referred to as the learning phase. During this learning phase, the ambient noise level is detected, and the filtering is adjusted so that this ambient noise can be suppressed.

German Patent Application 100 25 869 A1 describes one possibility of shortening the learning phase by an early start of the interference noise suppression algorithm. This is accomplished by the fact that when a connection is being established on a cell phone, the ambient noise is already detected during the dialing phase, i.e., before the connection is made, and the algorithm is started earlier accordingly.

### SUMMARY OF THE INVENTION

Based on these known methods, an object of the present invention is to suppress interference noise in hands-free phone use in motor vehicles; this further shortens the period of time for creating optimum call conditions and does not necessitate any major technological or computational expense. By inquiring as to the prevailing operating parameters in establishing a connection, the values for the interference noise suppression can be obtained directly from a characteristics map determined previously and saved, thus resulting in even faster adaptation of the voice and audibility quality of a cell phone in a vehicle.

The determination of the characteristics map in the application makes it possible to supply the best initial values for interference noise suppression for each driving situation.

Another advantage of the present invention is that the values stored in the characteristics map are constantly being readjusted to the prevailing conditions during a call and are stored as new characteristics map values at the end of the call. This is therefore a learning system, and instantaneous changes or aging phenomena, for example, which result in a different ambient noise level, are taken into account in a new call from the beginning.

### BRIEF DESCRIPTION OF THE DRAWINGS

These and other objects, features and advantages of the present invention will become more readily apparent from the following detailed description of currently preferred configurations thereof when taken in conjunction with the accompanying drawings wherein:

The sole FIGURE is a flow chart showing the algorithm according to the present invention for adjusting the interference noise suppression in hands-free use of a cell phone in a motor vehicle.

Use of a cell phone in a motor vehicle makes high demands on interference noise suppression. Hands-free talking when using a cell phone in a motor vehicle, as required by law, and the noise level prevailing already due to the vehicle are factors which necessitate a very rapid algorithm for interference noise suppression.

In the method according to the present invention, the cell phone is monitored in a first working step 10 to determine whether a connection is being established either outgoing from this cell phone or incoming from another telephone to this cell phone. For example, arrival of incoming calls can be detected or this can be signaled as a connection being established at the start of a dialing operation.

After detecting that a connection is being established on the cell phone, the instantaneous vehicle parameters are detected in a working step 11. These include, for example, the current vehicle speed v, rotational speed n, load L, as well as the current window position (window open or closed) and in the case of a convertible, for example, the position of the top (convertible top open or closed). These vehicle parameters are relayed via a corresponding system, e.g., a CAN bus, to a conventional type of control unit (not shown) for interference noise suppression. On the basis of the vehicle parameters thus determined, the starting parameters for the interference noise suppression are then obtained from a corresponding characteristics map in a working step 12. Thus, the interference noise suppression is already optimized at a possible start of a call. If a connection was not ultimately established in step 13, the system jumps directly to the end of this method. However, if a connection is established, then the interference noise suppression is further optimized in a following step 14. This algorithm is already known from the related art and will not be explained further here. Thus, the interference noise suppression algorithm is being optimized during the dialog. At the start of the algorithm, various computational data adapted to the vehicle and the situation is already available, so overall fewer calculations need be performed and a simpler computation unit may be used to implement the algorithm. After ending the call in working step 16, the parameters that have just been optimized are stored as the new starting parameters in the characteristics map in working step 17.

Thus, the characteristics map values for output of the starting parameters for the interference noise suppression are constantly being learned, and even wear phenomena or changes in vehicle conditions cannot have a negative effect on the optimum interference noise suppression. The content of the characteristics map is first determined in the application and stored as basic parameters in the control unit. Due to the possibility of storing the optimized parameters calculated during the call as new starting parameters at the end of a call, taking into account the prevailing vehicle parameters, this yields an improved and even faster adaptation to the prevailing ambient conditions.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. Method of suppressing ambient noise in a cell phone call to or from a motor vehicle, comprising measuring the ambient noise, determining parameters for suppressing the measured ambient noise, detecting vehicle parameters when a connection has been detected, and obtaining starting parameters for the ambient noise suppression from a characteristics map based on the currently detected vehicle parameters.

2. Method as claimed in claim 1, wherein the starting parameters are further improved during the call, further comprising storing the improved starting parameters as new starting parameters in the characteristics map.

3. Method as claimed in claim 1, wherein at least one of vehicle speed, load, rotational speed, window position, and optionally the position of a convertible top, if present, are determined as the vehicle parameters.
